(19) United States
(12) Patent Application Publication
(10) Pub. No.: US 2026/0132053 A1
(43) Pub. Date: May 14, 2026

(54) STORM WATER FILTRATION SYSTEM

(71) Applicant: Lily Zezula, Ridgefield, CT (US)

(72) Inventor: Lily Zezula, Ridgefield, CT (US)

(21) Appl. No.: 18/944,417

(22) Filed: Nov. 12, 2024

(51) Int. Cl. C02F 1/00; C02F 3/34; C02F 103/00

(52) U.S. Cl. CPC C02F 1/001; C02F 3/347; C02F 2103/001; C02F 2307/08

(57) ABSTRACT

In accordance with at least one aspect of this disclosure, a system for filtering storm water runoff comprises, a disposable filter configured to be placed directly in storm water drainage infrastructure for a prescribed filtration period after which the disposable filter is removed from the storm water drainage infrastructure. The disposable filter includes, a permeable container filled with a nutrient rich substrate and a plurality of spores embedded within the nutrient rich substrate configured to develop into mycelium over a prescribed growth period.

### TECHNICAL FIELD

The present disclosure relates to water filtration and more particularly to storm water filtration.

### BACKGROUND

Storm water is water that originates from precipitation (storm), including heavy rain and meltwater from hail and snow. In more natural environments, e.g., less developed or lacking impervious surfaces, storm water can soak into the soil and become groundwater or can pool and evaporate back into the atmosphere, if not directly runoff into a nearby water body. When storm water naturally permeates into the soil, the ground, soils and sediments, along with the plants rooted therein, serves as a natural filter for the storm water.

In developed environments however, such as cities or urban areas with large amounts of impervious surface (pavement, roads, parking lots, etc.), stormwater runoff often picks up pollutants left behind by cars, construction, pets, fertilizer and spills. Unmanaged and/or untreated stormwater can lead to potential contaminants flowing into nearby waterbodies since the water is unable to filter through the ground naturally. Such contaminated or polluted runoff poses a serious threat to wildlife and humans that rely on waterbodies that are directly fed by runoff for drinking or habitat, in addition to the environment as a whole.

While conventional filtering techniques exist to filter water for drinking or household use, for example, these solutions may not be practical for large scale implementation, such as for storm water filtration. Additionally, certain conventional methods are not able to effectively breakdown or filter plastics, heavy metals, or contaminants, and may simply filter larger particulate. This disclosure provides a solution for this need.

### SUMMARY

In accordance with at least one aspect of this disclosure, a system for filtering storm water runoff comprises, a disposable filter configured to be placed directly in storm water drainage infrastructure for a prescribed filtration period after which the disposable filter is removed from the storm water drainage infrastructure. The disposable filter includes, a permeable container filled with a nutrient rich substrate and a plurality of spores embedded within the nutrient rich substrate configured to develop into mycelium over a prescribed growth period.

The prescribed growth period can be about two weeks to about two months determined as a function of a type of spore embedded within the nutrient rich substrate. The prescribed filtration period can be about 35 days beginning after conclusion of the prescribed growth period. The prescribed filtration period can be determined as a function of a type of spore embedded within the nutrient rich substrate. The prescribed filtration period can end when the mycelium begin to flower, after which the filter can be replaced with a new filter.

In certain embodiments, the container can also be filled with one or more of hay, straw, or grain, in addition to the nutrient rich substrate. In certain embodiments, the permeable container can be formed of a fabric, for example burlap or linen. In certain embodiments, the permeable fabric can be or include a woven or non-woven geotextile fabric. In certain embodiments, the fabric can be biodegradable and can be configured to degrade at the conclusion of the prescribed filtration period.

In certain embodiments, the permeable container can be formed of a metal. The metal can include a plurality of metal filaments arranged in an interlocking geometric pattern (e.g., as in a fence or chicken wire) or the wire filaments can form a mesh.

In certain embodiments, the filter can be an elongated filter, extending from a first end to a second end along an axis. When placed in the storm water drainage infrastructure, the filter can be configured to be arranged such that the filter axis is perpendicular to a flow of storm water therethrough. In certain embodiments, the filter can be configured to be arranged such that the filter axis is parallel to a flow of storm water therethrough.

In certain embodiments, the system includes the storm water drainage infrastructure. The infrastructure can include, a street level inflow and an outflow connected by an underground conduit. In certain embodiments, the filter can be placed at any one or more of the inflow, the outflow, or in the conduit. In certain embodiments, the system can include a plurality of filters arranged directly within the storm water drainage infrastructure parallel to one another. In certain embodiments, the plurality of filters can be disposed at one or more of: downstream of the street level inflow, just below the inflow; within the underground conduit; and/or upstream of the outflow, just before the outflow. In certain embodiments, the plurality of filters can include a plurality of groups of filters, where each group contains a plurality of filters, and where each group is disposed at a different location within the storm water drainage infrastructure. In certain embodiments, the plurality of filters can be arranged within a group, where a portion of the filters within the group are oriented such that the filter axis is parallel to the flow of water there through and a portion of the filters within the group are oriented such that the filter axis is perpendicular to the flow of water there through.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, other embodiments thereof will be described in detail herein below with reference to certain figures, wherein:

FIG. 1 is a perspective, cutaway view of an embodiment of a storm water drainage infrastructure system in accordance with this disclosure, showing a plurality of filters disposed therein;

FIG. 2 is a perspective view of an embodiment of a filter;

FIG. 2A is an enlarged, localized view of the filter of FIG. 2, showing a nutrient rich substrate having mycelium growing therein;

FIG. 3 is a perspective view of a group of filters placed at a first location within storm water drainage infrastructure;

FIG. 4 is a perspective view of a group of filters placed at a second location within storm water drainage infrastructure;

FIG. 5 is a perspective view of a group of filters placed at a third location within storm water drainage infrastructure; and

FIG. 6 is a perspective view of a group of filters placed at the second location within storm water drainage infrastructure and arranged parallel to the flow direction.

### DETAILED DESCRIPTION

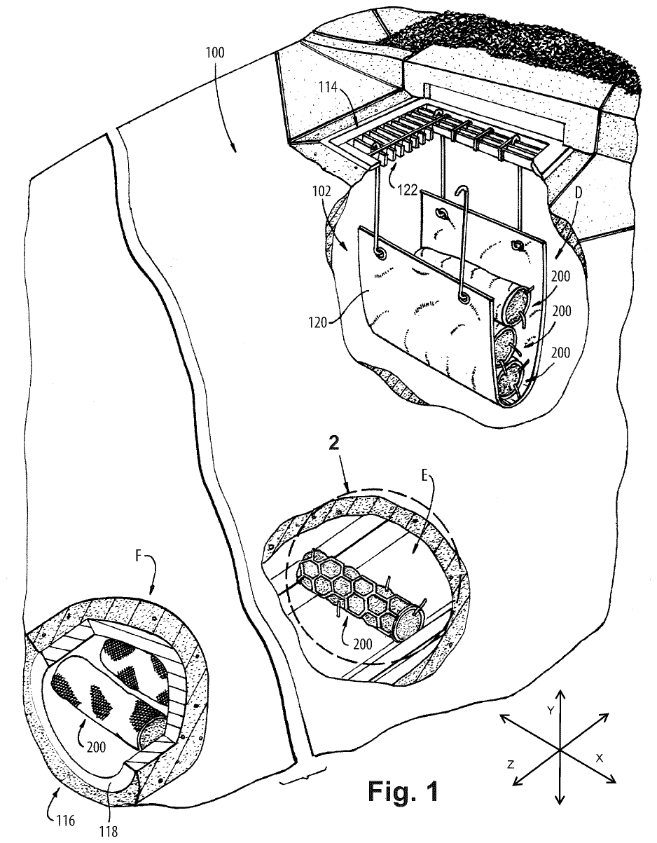

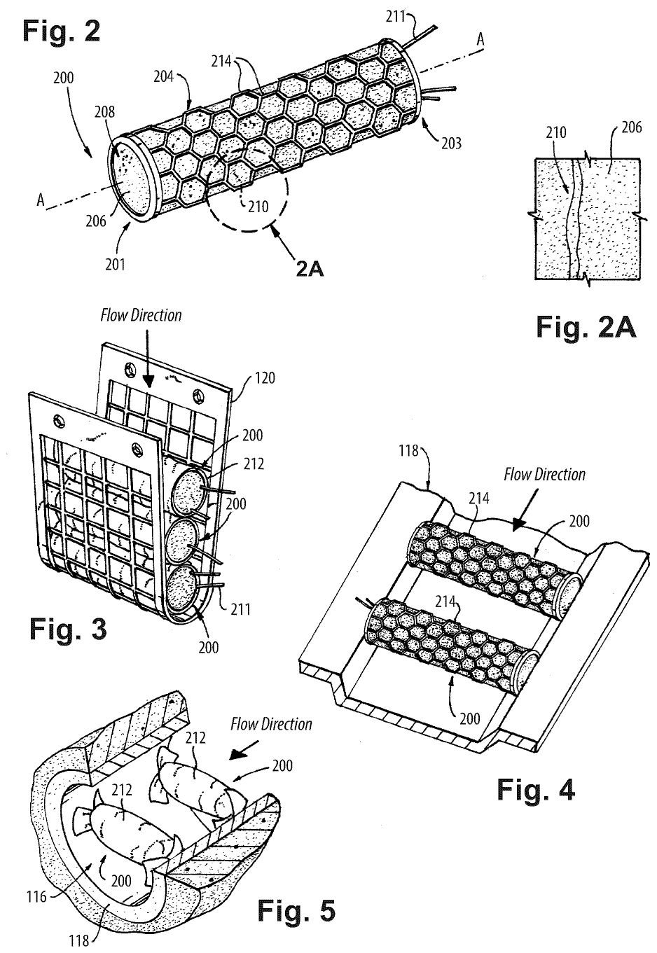

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2-5. Certain embodiments described herein can be used to improve filtration of storm water, to reduce run off containing certain pollutants and contaminants harmful to water supplies and wildlife.

In accordance with at least one aspect of this disclosure, and shown in FIG. 1, is an embodiment of a system 100 for filtering storm water runoff. The system 100 comprises, a disposable filter 200 configured to be placed directly in storm water drainage infrastructure 102 for a prescribed filtration period after which the disposable filter 200 is removed from the storm water drainage infrastructure 102 and replaced with a new filter at the beginning of its lifecycle.

As best seen in FIGS. 2 and 2A, the disposable filter 200 includes a permeable container 204 filled with a nutrient rich substrate 206 therein, and a plurality of spores 208 embedded within the nutrient rich substrate 206 configured to develop into mycelium 210 over a prescribed growth period. Mycelium are a network of underground fungal threads that grow from—mushroom spores, and eventually produce mushrooms as fruiting bodies. Mycelium are able to grow and thrive in many conditions, including ones that are highly contaminated. In such contaminated environments, mycelium release enzymes into the soil or substrate to break down pollutants, toxins, hydrocarbons, plastics, heavy metals, phosphates, and the like, many of which are found in storm water runoff. Certain mushroom mycelium, including oyster mushrooms are particularly good and breaking down these known pollutants. The spores 208 embedded in the nutrient rich substate 206 can include oyster mushroom spores, for example. The spores 208 can include a mixture of many different species of mushroom.

The prescribed growth period can be about two weeks to about two months determined as a function of a type (e.g., species) of spore 208 embedded within the nutrient rich substrate 206. For example, the prescribed growth period can be about two weeks. The prescribed filtration period can be about 35 days beginning after conclusion of the prescribed growth period. The prescribed filtration period can be determined as a function of a type (e.g. species) of spore 208 embedded within the nutrient rich substrate 206, for example, for an oyster mushroom this period can be about 10 days. The prescribed filtration period can end when the mycelium begin to flower, after which the filter 200 can be replaced with a new filter. The prescribed filtration period can also extend until the filter 200 itself deteriorates, even after the mycelium have begun to fruit. It is important to note however, that mycelium are continuously growing and filtering and may do so at different rates, and thus filtering and breakdown of pollutants can also occur during the prescribed growth period.

In certain embodiments, the container 204 can also be filled with one or more of hay, straw, or grain, 211 in addition to the nutrient rich substrate. The hay, straw, or grain 211 is configured to absorb, capture, and “hold onto” the pollutants broken down by the mycelium. This prevents the broken-down pollutants from reentering the storm water downstream of the filter 200. In certain embodiments, the permeable container 204 can be formed of a fabric 212, for example burlap, linen, or any other suitable natural woven fabric (e.g., as shown in FIG. 1 at location D, and FIG. 3). In certain embodiments, the fabric 212 can be biodegradable and can be configured to degrade at the conclusion of the prescribed filtration period. Such biodegradable embodiments eliminate the need for service workers to remove the used filters 200 before placing a new filter.

In certain embodiments, the permeable fabric 212 can be or include a woven or non-woven geotextile fabric (e.g., as shown in FIG. 1 at location F, and FIG. 5). The fabric 212 can be chosen as a function of a desired residence time of storm water within the filter 200. For example, a woven geotextile will have a much slower filtration rate than a nonwoven geotextile, thus woven geotextiles will increase the residence time of the storm water within the filter. Nonwoven geotextiles will have a much smaller residence time due to increased flow rate through the filter. The material of the container 204 can be chosen such that the residence time is such that to allow the mycelium to breakdown pollutants, but not so long that the filter 200 cannot pass the storm water in accordance with storm water drainage flow rate requirements.

In certain embodiments, the permeable container 204 can be formed of a metal (e.g., as shown in FIG. 1 at location E, and FIGS. 2 and 4). For example, the metal can include a plurality of metal filaments 214 arranged in an interlocking geometric pattern (e.g., as in a fence or chicken wire) or the wire filaments can form a mesh. Embodiments utilizing a metal container can be reused at the end of the filtration period and can be more durable to stand up to larger debris that enters the storm drain or storm water infrastructure 102.

In certain embodiments, as best seen in FIG. 2 for example, the filter 200 can be an elongated filter, extending from a first end 201 to a second end 203 along an axis A. When placed in the storm water drainage infrastructure 102, the filter 200 can be arranged within the infrastructure 102 such that the filter axis A is perpendicular to a direction of flow of storm water therethrough, for example as best seen in FIGS. 3-5. The first and second ends 201, 203 of the filter 200 can be tied shut and/or closed so that the contents within the filter do not fall into the passing storm water, such as shown in FIG. 5. The ends of the filter 200 are shown open in the remainder of the Figures for the sake of clarity, however, it should be appreciated by one having ordinary skill in the art in view of this disclosure, the ends of the filter 200 can be tied or otherwise closed regardless of where the filter 200 is disposed within the infrastructure 102.

With reference to FIGS. 1 and 3-5, the storm water drainage infrastructure 102 can include, a street level inflow 114 and an outflow 116 connected by an underground conduit 118, which is generally representative of conventional municipal drainage infrastructure, though it may vary across jurisdictions. The filter 200 can be placed at any one or more locations within the infrastructure 102. For example, the filter 200 can be placed at the inflow 114, e.g., downstream of, just below/after the inflow 114 as indicted in FIG. 1 by letter D. FIG. 3 also shows another view of the filters 200 placed at the inflow 114, where the filters 200 hang in a netting or naturally permeable fabric hammock 120, or are otherwise suspended from a drain 122 covering the inflow 114.

The filter 200 can alternatively or additionally be placed in the conduit 118, e.g., anywhere along the conduit, as shown in FIG. 1 by letter E. FIG. 4 shows an embodiment of a conduit 118, where the conduit is a trough or channel shape, and the filter lays across the channel, perpendicular to the flow of water therethrough. The filter 200 can additionally or alternatively be placed at the outflow 116, e.g., upstream of, just before the outflow 116, as indicated in FIG. 1 by letter F. This is also shown in FIG. 5, where an embodiment of the outflow 116 is shown having a generally cylindrical pipe shape, where the filters lay across the pipe, perpendicular to the flow of water therethrough. Any suitable number of filters 200 can be placed within the infrastructure 102, including at all three locations D, E, and F as described above.

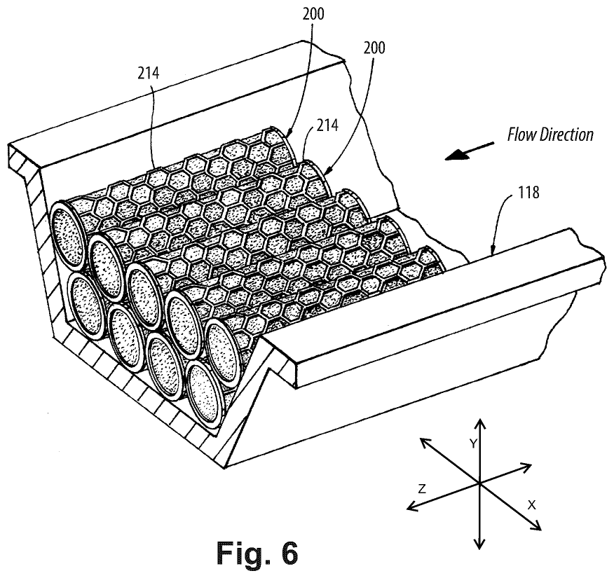

In certain embodiments, such as shown in FIG. 6 a group of filters 200 within the storm water drainage infrastructure 102 can be arranged parallel to the flow of storm water through the conduit 118. Though the example shown in FIG. 6 shows the filters 200 placed parallel to the flow direction at location E, it is contemplated that the filters 200 can be arranged in the stacked formation and arranged parallel to the flow direction as shown in FIG. 6, in any of the locations, D, E, or F (e.g., at the inflow 114, the outlet 116, or anywhere along the conduit 118).

The plurality of filters 200 can be arranged within the storm water drainage infrastructure 102 in any combination, for example, within a single group of filters 200, a portion of the filters 200 within the group can be oriented such that the filter axis is perpendicular to the flow of water therethrough (e.g., in the X direction as shown in FIG. 1) and a portion of the filters 200 within the group are oriented such that the filter axis is parallel to the flow of water therethrough (e.g., in the Z direction as shown in FIG. 6). By way of additional example, the filters 200 as shown in FIG. 6 are shown in two layers, where both layers are oriented in the same direction (e.g., the Z direction), parallel to the flow direction. Additional layers may be included atop, or interleaved, where the filters are arranged in a different direction (e.g., the X direction), perpendicular to the flow direction.

In certain embodiments, one or more filters 200 could also be arranged in the Y direction, which if the filters are placed at location D, results in a filter axis parallel to the flow of water therethrough. A filter axis along directions X and Z would be perpendicular to the flow of water there through, if placed at location D.

In certain embodiments, also shown in FIG. 1, a plurality of filters 200 can be arranged directly within the storm water drainage infrastructure 102 parallel to one another and can be grouped together, where each group contains a plurality of filters. Each group can be disposed at a different location within the storm water drainage infrastructure 102, also shown in FIG. 1. The number of filters in each group, the number of groups of filters, and the placement of filters can be determined as a function of desired residence time of storm water within the filters, and to more readily accommodate storm water in event of heavy rain or flooding, for example.

One of the major environmental concerns for marine animals is water pollution. Water pollution occurs when harmful substances, like chemicals or plastics, contaminate a stream, river, lake, or ocean, degrading water quality and making it toxic to humans and the environment. One of the major contributors to this pollution comes from storm water runoff.

Certain storm water management solutions already exist for capturing storm water runoff, for example, rain gardens, permeable pavement, and retention ponds. Rain gardens prevent stormwater runoff by absorbing and filtering rainwater, which reduces the amount of water flowing into storm drains. Permeable pavement is made of porous material that allows the rainwater to seep through the surface and into the ground below, which can help to resupply groundwater and reduces the amount of storm water runoff that needs to be managed. Retention ponds temporarily store rainwater, allowing it to slowly go back into the ground, which can help reduce the amount and speed of stormwater flowing into waterways. While these existing solutions may be effective, they are not as easily scalable as the inventive filter described herein, nor do they filter pollutants out of the storm water before it returns to a larger water body or to ground water.

Because of the amount of impervious surface that exists in highly developed areas, there is a considerable amount of storm water runoff that carries pollutants that need to be treated before it goes into storm drains, and that is not captured by a rain garden, or retention pond, for example. The system for filtering storm water runoff (e.g., system 100), described herein provides the solution to this need.

Certain fungi can take pollutants, such as plastic and oil and can break them down with their enzymes through a process called mycoremediation. Mycoremediation is the use of fungi for the removal of waste from the environment. Mycelium, which are the mushrooms roots, can absorb oils and heavy metals from soils and waters. As the mycelium grows it release enzymes that breakdown these toxic substances making them less harmful. Fungi can absorb and breakdown contaminants in polluted water thereby improving water quality and downstream marine life.

The system for filtering storm water runoff (e.g., system 100) can include elongated “pipe” shaped filters filled with mycelium embedded in a substrate and place the filters in various locations within a storm drain, for example, hanging from a storm drain grate, in a storm drain conduit underground, and/or out an outlet of the storm drain conduit. Since the filters are placed underground, and directly within the storm drain infrastructure, there is no risk for cars to run over, or otherwise destroy the filters. The filters can also have straw mixed with mycelium roots within them to capture the pollutants, while the mycelium would absorb and break down the pollutants through mycoremediation.

The system for filtering storm water runoff (e.g., system 100) as shown and described helps capture and breakdown pollutants that come directly from stormwater runoff. Typically, because stormwater flows over hard surfaces directly into storm drains, there is no opportunity for soil and plants to filter out pollutants naturally. This can have a negative impact on our water quality. Thus, a goal of the system for filtering storm water runoff as shown and described herein is ultimately to improve the water quality of all water bodies, in particular, those fed by storm water runoff.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

What is claimed is:

1. A system for filtering storm water runoff, comprising:
a disposable filter configured to be placed directly in storm water drainage infrastructure for a prescribed filtration period after which the disposable filter is removed from the storm water drainage infrastructure, the disposable filter including:
a permeable container filled with a nutrient rich substrate; and
a plurality of spores embedded within the nutrient rich substrate configured to develop into mycelium over a prescribed growth period.

2. The system of claim 1, wherein the prescribed growth period is about two weeks to about two months determined as a function of a type of spore embedded within the nutrient rich substrate.

3. The system of claim 2, wherein the prescribed filtration period is about 35 days beginning after conclusion of the prescribed growth period, the prescribe filtration period being determined as a function of a type of spore embedded within the nutrient rich substrate.

4. The system of claim 1, wherein the permeable container is further filled with one or more of hay, straw, grain.

5. The system of claim 1, wherein the permeable container is formed of a fabric.

6. The system of claim 5, wherein the fabric includes burlap or linen.

7. The system of claim 5, wherein the fabric is biodegradable and is configured to degrade at conclusion of the prescribed filtration period.

8. The system of claim 1, wherein the permeable container is formed of a metal.

9. The system of claim 8, wherein the metal includes a plurality of metal filaments arranged in an interlocking geometric pattern or as a mesh.

10. The system of claim 1, wherein the filter is an elongated filter extending from a first end to a second end along an axis, wherein the filter is configured to be arranged directly within the storm water drainage infrastructure such that the axis is perpendicular to a flow of storm water therethrough.

11. The system of claim 10, further comprising a plurality of filters configured to be arranged directly within the storm water drainage infrastructure parallel to one another.

12. The system of claim 11, wherein the storm water drainage infrastructure includes a street level inflow and an outflow connected by an underground conduit, wherein each of the filters of the plurality of filters are configured to be disposed just below the street level inflow.

13. The system of claim 12, wherein the plurality of filters configured to be disposed downstream of the street level inflow, just below the street level inflow drain are suspended from a grate cover of the street level inflow.

14. The system of claim 11, wherein the plurality of filters are disposed within the underground conduit.

15. The system of claim 11, wherein the plurality of filters are disposed upstream of the outflow, just before the outflow.

16. The system of claim 11, wherein the plurality of filters are configured to be disposed at each of: downstream of the street level inflow, just below the inflow; within the underground conduit; and upstream of the outflow, just before the outflow.

17. The system of claim 1, further comprising: the storm water drainage infrastructure,
wherein the storm water drainage infrastructure includes a street level inflow and an outflow connected by an underground conduit, wherein each of the filters of the plurality of filters are configured to be disposed just below the street level inflow,
wherein the filter is an elongated filter extending from a first end to a second end along an axis, wherein the filter is configured to be arranged directly within the storm water drainage infrastructure such that the axis is perpendicular to a flow of storm water therethrough.

18. The system of claim 17, further comprising a plurality of filters arranged directly within the storm water drainage infrastructure parallel to one another.

19. The system of claim 18, wherein the plurality of filters are disposed at one or more of: downstream of the street level inflow, just below the inflow; within the underground conduit; and/or upstream of the outflow, just before the outflow.
